(19) United States
(12) Patent Application Publication
(10) Pub. No.: US 2026/0170827 A1
(43) Pub. Date: Jun. 18, 2026

(54) SYSTEMS AND METHODS OF USING ARTIFICIAL INTELLIGENCE TO UNDERSTAND VIDEO CONTENT

(71) Applicant: Cynapse Pte. Ltd., Singapore (SG)

(72) Inventors: Guy Ron, Singapore (SG); Noam Berda, Singapore (SG); Prabodh Tripathi, Singapore (SG); Hizkia Felix, Singapore (SG); Nitin Gururaj Kallur, Singapore (SG)

(21) Appl. No.: 18/981,227

(22) Filed: Dec. 13, 2024

(51) Int. Cl. G06V 20/40; G06V 10/82; G06V 20/70; G06V 30/262

(52) U.S. Cl. CPC G06V 20/41; G06V 10/82; G06V 20/46; G06V 20/70; G06V 30/262

(57) ABSTRACT

A multi-tiered video content understanding system includes a frame preprocessing module that receives encoded video, decodes it to create a decoded video, and selects key frames corresponding to a scene. A scene understanding module, comprising three tiers, receives these key frames. The first tier, e.g., isolates an object in the scene by detecting and segmenting the object in at least one key frame and applying computer vision logic to identify object information. The second tier includes a VLM that vectorizes key frames containing the object to create a vectorized object images. The third tier includes a vision large language module (VLLM) that generates a contextual description of the scene using the vectorized object image and/or object information. The scene understanding module outputs a detailed frame document that is generated using outputs from each of the three tiers.

### FIELD OF THE INVENTION

The field of the invention is using VLM and VLLMs to generate comprehensive and contextualized understandings of video content.

### BACKGROUND

The background description includes information that may be useful in understanding the present invention. It is not an admission that any of the information provided in this application is prior art or relevant to the presently claimed invention, or that any publication specifically or implicitly referenced is prior art.

Scene understanding has traditionally been achieved through the use of machine learning and computer vision models, including detectors, classifiers, and segmentation models. These models analyze visual data to recognize the presence, location, and boundaries of specific objects. Traditional scene understanding tools, which include detectors, classifiers, and segmentation models, have limitations such as needing fine-tuning for specific use cases, providing only object-level understanding, lacking general context of the scene, and not inherently understanding object-object interactions.

Although existing technologies can nevertheless be useful for things like object search based on object attributes, generating alerts based on object attributes, and triggering alerts based on object-object interactions, traditional scene understanding tools are limited in their inability to perform comprehensive scene analysis and provide a detailed breakdown of the objects in the scene.

With the advent of Large Language Models (LLMs) and Open Vocabulary Vision Language Model (sometimes referred to as Vision Language models, or VLMs), scene understanding can improved by prompting VLLMs with both images and text. But these models lack capabilities in localizing objects as well as identifying object-object relationships. Moreover, VLLMs require immense processing power. Thus, there exists a need in the art for improved scene understanding that leverages large language models to carry out object detection, object attribute classification, and to determine object-object interactions to create detailed descriptions and searchable text for video-based events that can operate in real time on live video without any VLLM-based slowdown.

### SUMMARY OF THE INVENTION

The present invention provides apparatus, systems, and methods directed to video interpretation using VLLMs. In one aspect of the inventive subject matter, a multi-tiered video content understanding system is contemplated. The system comprises: a frame preprocessing module configured to receive encoded video; the frame preprocessing module being further configured to decode the video to create a decoded video and to select key frames from the decoded video, where the key frames correspond to a scene; a scene understanding module comprising a first tier, a second tier, and a third tier; where the scene understanding module is configured to receive the key frames from the frame preprocessing module; the first tier being configured to isolate an object in the scene by detecting the object in at least one key frame, segmenting the object in the at least one key frame into a segmented object image, and applying a computer vision logic system to the at least one key frame to identify object information; the second tier comprising a VLM that is configured to vectorize at least a portion of the at least one key frame that contains the object to create a vectorized object image; the third tier comprising a VLLM that is configured to generate a contextual description of the scene based on the at least one key frame using the vectorized object image and/or the object information; and where the scene understanding module outputs a detailed frame document comprising the contextual description of the scene and the vectorized object image.

In some embodiments, the first tier is further configured to generate information about the object, the information about the object comprising at least one of a tracking ID, a location of the object, a duration that the object appears in the scene, an indicator as to whether the object is moving or stationary, a direction of movement, and whether the object is in a region of interest. The contextual description of the scene can also include the object information. In some embodiments, the VLM comprises a Contrastive Language-Image Pre-training model (CLIP) model, and the VLM can include an image encoder configured to vectorize images.

The key frames can be a subset of total frames that make up the scene from the decoded video. In some embodiments, the third tier can generate the contextual description of the scene by running a pre-defined query.

In another aspect of the inventive subject matter, a multi-tiered video content understanding system comprises: a frame preprocessing module configured to receive a video and to identify key frames in the video that correspond to a scene; a scene understanding module comprising a first tier, a second tier, and a third tier; the first tier being configured to identify an object in a key frame and to generate object information about the object; the second tier comprising a VLM that is configured to create a vectorized image containing the object; and the third tier comprising a VLLM that is configured to apply a predefined query to generate a contextual description of the key frame.

In some embodiments, the frame preprocessing module receives an encoded video and the frame preprocessing module decodes the encoded video to create the video. In some embodiments, the object information includes at least one of a tracking ID, a location of the object, a duration that the object appears in the scene, an indicator as to whether the object is moving or stationary, a direction of movement, and whether the object is in a region of interest. The contextual description of the object in the scene can also include the information about the object.

In some embodiments, the first tier is further configured to apply a computer vision logic system to the segmented object image. The VLM can include an image encoder configured to vectorize images. The key frames can be a subset of total frames that make up the scene from the video. The VLM can feature a Contrastive Language-Image Pre-training model (CLIP) model, and the first tier can additionally include an OCR sub-module.

In some embodiments, the third tier uses the object information and the vectorized image to generate the contextual description of the key frame.

One should appreciate that the disclosed subject matter provides many advantageous technical effects including the ability to generate contextualized information about video content in real-time.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic showing how different video sources can feed video content into a frame preprocessing module of the inventive subject matter.

FIG. 2 is a schematic describing frame preprocessing that occurs before passing video content on to a scene understanding module.

FIG. 3 is a schematic describing a scene understanding module of the inventive subject matter.

FIG. 4 is a flowchart describing a method of the inventive subject matter focusing on frame preprocessing and a scene understanding module.

FIG. 5 is a flowchart showing an output from a scene understanding module.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

In this application, the phrasing “at least one of X, Y, and Z” may be used. This usage is intended to mean “one or more of X, one or more of Y, or one or more of Z, or any combination of one or more of X, one or more of Y, and one or more of Z.”

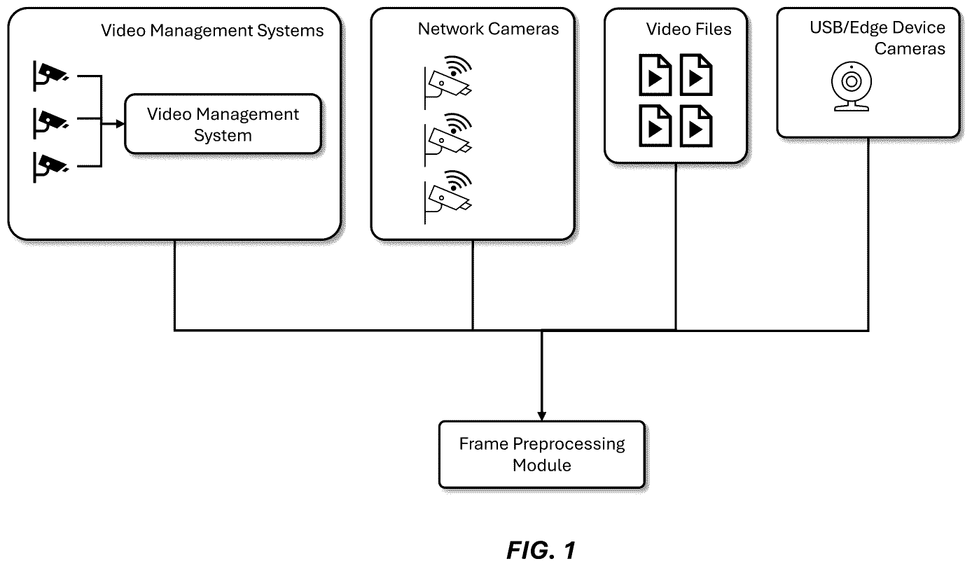

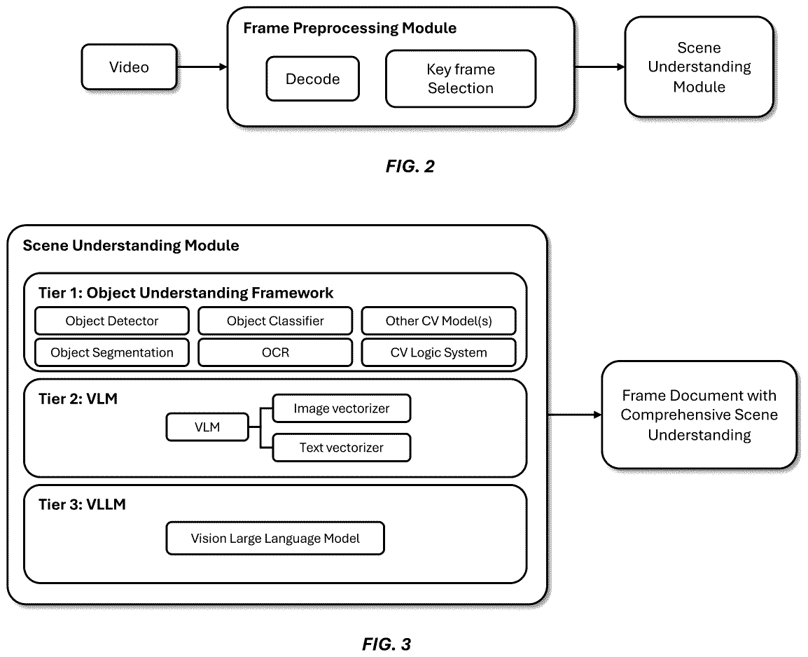

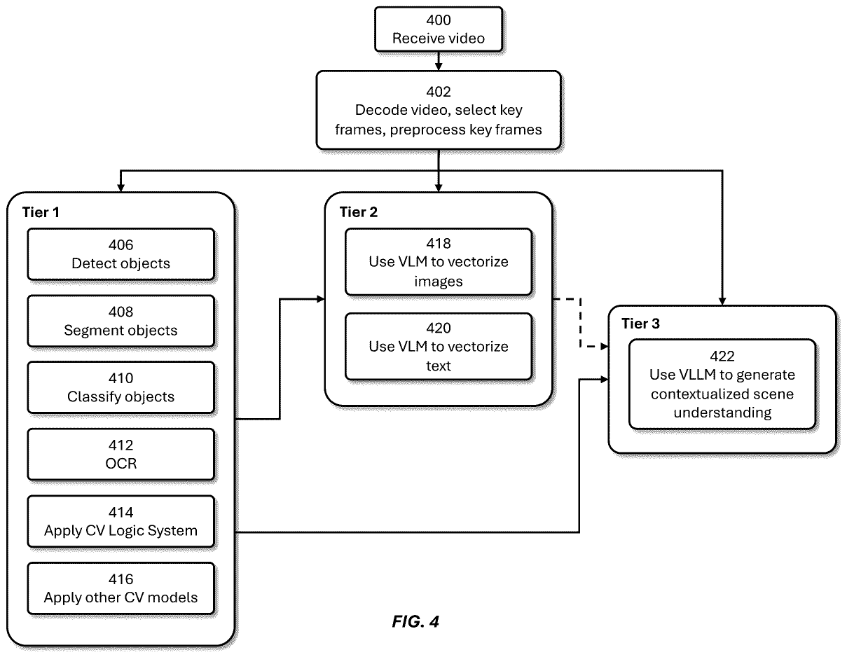

Systems and methods of the inventive subject matter take a three-tiered approach to scene understanding that includes tools to obtain deep insights of scenes that exist within videos. FIG. 1 is a schematic showing how different video sources can feed video content into a frame preprocessing module of the inventive subject matter. FIG. 2 is a schematic describing frame preprocessing that occurs before passing video content on to a scene understanding module that is described in FIG. 3.

According to FIG. 1, video content can come from a variety of sources. For example, a Video Management System (VMS) can provide video. Camera feeds are often managed by a VMS, which is responsible for recording video streams, changing settings, and providing camera feed access to external service providers. Camera feeds from a VMS can thus be fed into a frame preprocessing module of the inventive subject matter.

In other embodiments, video files that contain pre-rerecorded video can be fed into a frame preprocessing module. Video files can be stored either locally (e.g., on local storage) or remotely (e.g., on remote storage, on a server, cloud storage, or the like). This allows embodiments of the inventive subject matter to handle not only live video, but also recorded video to assist with, e.g., forensic analysis of video content.

In some embodiments, video streams from networked cameras can be fed directly into a frame preprocessing module. Directly feeding a video stream refers to passing video that is sent over a network connecting to a frame preprocessing module instead of having the video stream pass through a server or cloud, first. This can mean that a video stream is transmitted via local area network or that it passes over an internet connection in a way that it does not route through, e.g., any kind of third-party service (outside of ordinary network traffic routing).

In some embodiments, edge or USB cameras can generate video that is passed into a frame preprocessing module. These types of cameras can be configured for mobility and thus may generate video streams that need to be transmitted to different machines for processing.

In any event, a wide variety of video sources can transmit video to a frame preprocessing module of the inventive subject matter. Frame preprocessing modules can operate on a local or remote/cloud machines, or any other type of computing device configured to receive video content and that is capable of carrying out frame preprocessing tasks described in this application.

Frame preprocessing modules of the inventive subject matter are responsible for preparing video frames for processing by, e.g., computer vision models (which are incorporated into the scene understanding module described below). Frame preprocessing modules ensure that, e.g., key frames are optimized and tailored for scene understanding modules of the inventive subject matter, enhancing both computational efficiency and model accuracy. Key functions of frame preprocessing modules include decoding video streams, key frame selection, and preprocessing tasks (e.g., resizing, cropping, and so on).

Thus, according to FIG. 2, video content is passed from a video source to a frame preprocessing module. A module is a process or set of processes that exists in software, where that software can be run either locally (e.g., on a personal computer, smart device, or the like) or remotely (e.g., on a server, a set of servers, a cloud server, or the like). Video content and videos comprise scenes, such that the terms video and video content refer to any kind of video (e.g., live, pre-recorded, or any other format of video) while the term scene refers to some activity captured in a video or video content (e.g., a portion of some security camera footage, a news broadcast, home videos, YouTube videos, and so on). Videos can comprise multiple scenes, and scenes can overlap with other scenes.

The frame preprocessing module has two primary functions: decoding and frame selecting. All digital video content is encoded or compressed in some way, and video decoding is the process of converting an encoded or compressed video stream into a format that can be displayed on a screen or can be subject to further processing. When a frame preprocessing module receives video from, e.g., a video management system (VMS), from network-based cameras, from video files, from USB/edge device cameras, or the like, the video is encoded in some manner. Videos are often encoded using compression algorithms to reduce storage and bandwidth requirements, which must be decoded into raw frames to make further processing possible.

Decoding can involve using hardware or software to uncompress video and audio streams. Video passed to the frame preprocessing module can exist in a compressed format to facilitate transmission over network connections, and the frame preprocessing module can thus decode incoming video to bring it into a format that can be used by the scene understanding module.

Some common codecs include H.264/AVC (Advanced Video Coding), H.265/HEVC, MPEG-4, and MJPEG. H.264/AVC is widely used in surveillance, streaming, and storage systems. H.265/HEVC (High Efficiency Video Coding) is an advanced codec offering high compression efficiency. MPEG-4 is commonly used in multimedia applications. MJPEG (motion JPEG) is often used in video surveillance for simplicity and compatibility. Frame preprocessing modules of the inventive subject matter can be configured to handle a wide variety encoded videos, where decoding capabilities are limited only by processing power. Frame preprocessing modules should be able to handle different bitrates and frame rates in different video streams, and they should be capable of efficiently managing resource usage (e.g., hardware and software resources) to ensure decoding occurs in real time.

The second task that the frame preprocessing module carries out is frame selecting. In video surveillance, for example, frame selecting is a process by which key frames from a video stream are identified and sometimes extracted (e.g., to create a scene, as described below). This process helps in summarizing video content. In some embodiments, key frames represent and are identified according to significant changes or events in a video, while in other embodiments keyframes are selected at regular intervals, at random, by clustering procedures, or according to another selection scheme. Key frames can be used by embodiments of the inventive subject matter to, e.g., summarize surveillance videos by detecting multiple change points and segmenting the video into scenes to create concise and informative summaries video content.

Not all frames of a decoded video may be relevant to a scene understanding module. Thus, selecting frames judiciously is critical to balance computational efficiency and task accuracy. Frame rates of incoming video can be high (e.g., 30+ FPS) or low (e.g., less than 30, though generally in the range of 5-10 FPS). High frame rates can be necessary for, e.g., computer vision models that track dynamic or rapidly changing objects—such as a vehicle detection model—where object locations can change significantly between frames. Lower frame rates can be suitable for, e.g., computer vision models that analyze relatively static attributes and objects, such as a vehicle color classifier, where color information remains relatively constant over time. Key frame selection can be adjusted depending on video frame rate as well as expected content in a video (e.g., if high speed movements are expected, more key frames may be selected to ensure those movements are adequately captured in the selected key frames).

A variety of frame selection techniques can be implemented, including uniform sampling and dynamic sampling. With uniform sampling, the frame preprocessing module selects frames at fixed intervals. With dynamic sampling, the frame preprocessing module selects frames at variable intervals, where the selection rate can be adjusted according to requirements of, e.g., a computer vision model deployed in a scene understanding module, other aspects of the scene understanding module, content of the video that key frames are being selected from, and so on.

Clustering methods can also be implemented to give rise to intelligent frame selection. Algorithms like K-means, DBSCAN, and other hierarchical clustering techniques can be used to group similar frames based on features such as color histograms, edge patterns, or deep feature embeddings. Representative frames from each cluster are then selected as key frames to ensure diversity in key frames while minimizing redundancy. This approach can be useful for summarization tasks or when processing long, unchanging scenes, as it prioritizes capturing key variations without unnecessary duplication.

Key frames that the frame preprocessing module identifies correspond to scenes in videos. Key frames are representative of scenes. In some embodiments, a set of key frames corresponds to a scene that comprises multiple frames around each key frame in the set of key frames or that is bounded by the keyframes (e.g., a scene can be a segment of a video that starts at a first key frame in a set and ends with a last key frame in a set), and in some embodiments a set of key frames that are selected make up a scene. For example, if a scene is 350 frames long, then the set of key frames can have 350 frames. In some embodiments, key frames the frame preprocessing module identifies can be some subset of the total frames making up a scene (e.g., such the key frames making up a scene can playback the scene at a lower frame rate than the video the scene came from would ordinarily playback at).

In some embodiments, key frames can be passed to the scene understanding module as they are extracted from a video, and whether a set of key frames makes up a scene (and what key frames should be in that set) can be determined after processing by the scene understanding module has taken place. This can be true in circumstances where characteristics that define a scene cannot be known until after key frames have been fully processed and understood. For example, it may be useful to create a scene from a video where the scene includes every key frame where a scene is one in which a red ball appears, and that information cannot be known until the key frames are fully processed and the “scene” has been understood—then it can be identified as a scene. How quickly key frames can be passed to a scene understanding module from a frame preprocessing module can depend on available processing power—more processing power facilitates faster key frame selection and faster key frame processing.

Thus, because embodiments of the inventive subject matter operate in real time, key frames can be sent from the frame preprocessing module on an individual basis as a video is received by a frame preprocessing module. Because in most circumstances, key frames selected by the frame preprocessing module are a subset of total frames in a video, the scene understanding module can then receive each key frame and carry out its scene understanding tasks (as discussed below) without processing slowdown that may occur if every single frame from a video is sent to the scene understanding module. Thus, when describing a “set of key frames” as being transmitted to the scene understanding module, it should be understood that this process can occur over a period of time where each key frame in the set is sent to the scene understanding module for further processing sequentially.

After the frame preprocessing module selects frames (e.g., as each key frame is selected, preprocessing can be carried out essentially in real time), each selected key frame can undergo additional preprocessing to align with specific requirements of a scene understanding module (e.g., requirements of computer vision models incorporated into a scene understanding module). Additional preprocessing can involve resizing, cropping, low-light enhancing, and other model-specific preprocessing (e.g., preprocessing that accounts for aspects of a scene understanding module that will process the key frames). Resizing can be used to adjust frame dimensions to match an input size that a scene understanding module expects (e.g., resizing to 224×224 pixels for classification models such as ResNet). Cropping can be used to extract or limit a frame to specific regions of interest (ROIs) to eliminate irrelevant information so that a target area can be focused on by a scene understanding module. Low-light enhancing involves altering frames captured in poor light conditions to improve scene understanding module performance (e.g., computer vision model performance) in low-visibility scenarios.

In some embodiments, frame preprocessing modules can perform edge detection or blurring. For example, edge enhancement and Gaussian blurring can be applied to frames to improve performance of a scene understanding module that receives them. Color space conversion can also improve scene understanding module performance. By converting all or portions of key frames to alternative color spaces like HSV (hue, saturation, and value), HSL (hue, saturation, and lightness), or grayscale, scene understanding modules of the inventive subject matter can operate more efficiently depending on the tasks undertaken.

Thus, frame preprocessing modules of the inventive subject matter can carry out the tasks described above, which includes decoding, frame selecting, and video preprocessing before transmitting preprocessed key frames (e.g., sequentially, in real time, as a set, etc.) to a scene understanding module. In some embodiments, the frame preprocessing module can be implemented on the same hardware and can even be part of the same software implementation as the scene understanding module. Thus, although the term “transmit” may be used to describe sending key frames from a frame preprocessing module to a scene understanding module, because modules exist as software implementations, the term can be considered as describing the ability of software of the inventive subject matter to use key frames once those key frames have been identified by the frame preprocessing module of the same software (or different software in instances where, e.g., different software tasks are distributed across different computing devices).

Scene understanding modules of the inventive subject matter, as shown in FIG. 3, feature a multi-tiered approach to scene understanding, which includes tools that help to obtain deep insights of scenes that are passed to the scene understanding module from the frame preprocessing module. Tier 1 implements an object understanding framework, Tier 2 implements a VLM (e.g., OpenCLIP, CLIP, ALIGN, ViLT, or the like), and Tier 3 implements a VLLM (Vision Large Language Model). A scene understanding module of the inventive subject matter thus receives key frames that has been preprocessed by the frame preprocessing module so that each tier within the scene understanding module is able to process those key frames more efficiently.

Key frames are processed by each of the tiers, starting with Tier 1. Tier 1 receives preprocessed key frames from the frame preprocessing module and creates an object level understanding of what is shown in the key frames (and by extension in a scene that the key frames represent). Tier 1 can thus facilitate detection and generation of alerts according to predefined rules and settings. For example, an alert can be set to trigger when a car is detected in one or more of the key frames of a scene, and a car can be detected according to an object understanding framework implemented in Tier 1.

The object understanding framework in Tier 1 is configured for high key frame throughput capacity with support for multiple, simultaneous real-time streams. It can process key frames to carry out tasks including object detection, object classification, and OCR. Because it is a highly optimized pipeline, an object understanding framework implemented by Tier 1 can be capable of processing multiple key frames per second without any drop in performance. Thus, Tier 1 carries out basic object identification tasks.

Tier 1 (i.e., the object understanding framework) features a number of sub-modules, including one or more object detectors, one or more object classifiers, an object segmentation module, an OCR module, a computer vision logic system, and other computer vision models. Each of these modules can work together or separately as needed to create an output that can facilitate deep understanding of a scene.

Although in some embodiments, certain sub-modules act before or after other modules, it should be understood that no specific order of operations for sub-modules can be elucidated because how an object understanding framework prioritizes use of its sub-modules is embodiment and circumstance dependent. Though while sub-module order depends on a domain or a use case, in most instances object detection comes first, followed by object segmentation to get more accurate boundaries of a detected object. In some embodiments, though, a Segment Anything Model (SAM) can be implemented. SAM models can segment out all important objects in a set of key frames without using a separate object detector.

Object detector modules are responsible for detecting objects that exist in key frames. Object detection is a technique that uses neural networks to localize and classify objects in images. It involves training computers to see as humans do, specifically by recognizing and classifying objects according to semantic categories. Object detection combines subtasks of object localization and classification to simultaneously estimate the location and type of object instances in one or more key frames.

Object segmentation, also known as image segmentation, is the process of partitioning a digital image into multiple image segments, also known as image regions or image objects. The goal of segmentation is to simplify and/or change the representation of an image into something that is more meaningful and easier to analyze by, e.g., isolating an object in a key frame. This technique is typically used to locate objects and boundaries (lines, curves, etc.) in images. Each of the pixels in a region are similar with respect to some characteristic such as color, intensity, or texture. Thus, an object segmentation module is responsible for carrying out object segmentation for objects that appear in key frames.

In some embodiments, an OCR module is also included. An OCR module can be responsible for recognizing and extracting text from key frames. OCR modules of the inventive subject matter can be implemented to enable text searching within key frames of a scene that is subject to processing by a scene understanding module (and specifically Tier 1 of the inventive subject matter).

Object understanding frameworks can also include computer vision (CV) logic systems. Computer vision logic systems are designed to enable computers to interpret and understand visual information. These systems can use a combination of image processing, machine learning, and deep learning techniques to analyze images and videos. They can perform tasks such as object detection, image classification, and scene understanding. Embodiments thus implement computer vision logic systems to facilitate scene understanding. For example, once object detection and segmentation have taken place for a key frame, a computer vision logic system can make sense of objects present in the key frame and, as more key frames are analyzed, a computer vision logic system can also discern information relating to how multiple objects interact in a scene.

Computer vision logic systems receive an input and produce and output. Inputs can include outputs from computer vision models (e.g., computer vision models that act as detectors, at as classifiers, create segmentations, and so on) and regions of interest (ROI) that are either predefined or given by a user. A computer vision logic system is thus responsible for gathering rule-based information (e.g., about one or more objects) from key frames, including: a tracking ID, a location of an object, a duration that an object appears in a scene as represented by key frames, an indicator as to whether an object is moving or stationary, a direction of movement, and whether an object is in a region of interest. Outputs from a computer vision logic system can be used for, e.g., alert generation.

Object understanding frameworks of the inventive subject matter implement a number of features that improve efficiency. For example, in some embodiments, smaller computer vision models can be used. Ordinarily, computer vision models are trained using a machine learning library. For example, PyTorch can be used to enable quick and easy model training. PyTorch is an open-source machine learning library for Python developed by Facebook's AI Research Lab (FAIR). It is one of the most popular deep learning frameworks, alongside others such as TensorFlow and PaddlePaddle. PyTorch offers a rich ecosystem of tools and libraries that support development in computer vision, natural language processing (NLP), and more.

Trained computer vision models can have assigned weights in, e.g., FP32 format. FP32, also known as single-precision floating-point format, is a computer number format that occupies 32 bits in memory. It represents a wide dynamic range of numeric values by using a floating radix point. This format is commonly used in scientific calculations and AI/deep learning applications. FP32 consists of 1 bit for the sign, 8 bits for the exponent, and 23 bits for the mantissa, allowing it to represent numbers with approximately 7-9 significant decimal digits. Quantization can then be used to convert computer vision models to use either FP16 or INT8 weights. This reduces model size and increases inference speed without giving rise to meaningful impacts to accuracy. Another way of reducing model size and increasing inference speed is through distillation. Trained computer vision models (i.e., teacher models) can be used further to train smaller computer vision models (i.e., student models).

In some embodiments, computer vision models can be designed to efficiently use available resources. Because multiple computer vision models can be used in a scene understanding module, object understanding frameworks of the inventive subject matter can be optimized to minimize data transfer from host (e.g., CPU) to device (e.g., GPU) and vice versa. Parallel processing can also be implemented so that independent computer vision models can run simultaneously.

An object understanding framework of Tier 1 thus uses all or a subset of the identified sub-modules to discern information about objects that appear in key frames that correspond to a scene. Object metadata that can be generated can include rule-based enrichments such as a tracking ID, a size/aspect ratio, a location (e.g., bbox, center), whether the object is stationary or moving, a movement direction (if applicable), an indicator as to whether an object exists within an ROI, and a duration that an object is present within a scene as represented by a set of key frames. Model based enrichments can also be generated, including an object crop embedding vector, object specific attributes, object segmentations, and so on.

Once key frames have been processed according to Tier 1, objects in the key frames will have been identified and segmented, any text will have been recognized via optical character recognition (OCR), and interactions between objects in the key frames will be discerned and understood. In the broader context of computer vision, understanding object interactions means recognizing how objects within key frames interact with each other over time. This involves tracking objects, analyzing their movements, and understanding their behaviors and relationships. For instance, in surveillance video content, understanding object-object and human-object interactions is fundamental. Visual tracking algorithms follow objects manipulated by humans as well as objects that are impacted or affected by other objects, providing useful information to model such interactions. This capability is essential for applications like surveillance, where recognizing and understanding interactions between humans and/or objects in a scene or video can enhance interaction realism. Thus, Tier 1 generates object information, where object information can include any of the parameters, metadata, or information about an object discussed regarding Tier 1.

Tier 2 implements a Vision and Language Model, or VLM (e.g., OpenCLIP, CLIP, ALIGN, ViLT, or the like) that can use the object level understanding developed in Tier 1 to vectorize objects (e.g., images cropped to show only or predominantly the object) and images (e.g., images containing visual information that a user may want to search for) within the key frames, and in some cases to vectorize entire key frames. Thus, outputs from Tier 1 can be used in Tier 2 in several ways. For example, Tier 1 outputs can facilitate vectorizing cropped images that contain objects (e.g., for use with text-based image searching or with VLLM processing in Tier 3). One or more of the sub-modules in Tier 1 can detect objects (e.g., vehicles, people, traffic lights, posters, road signs, etc.) and then create bounding boxes around those objects. The bounding boxes can then be cropped and resized (e.g., to a VLM's required image input size) before being vectorized using a VLM's image encoder.

Objects are detected and preprocessed (e.g., cropped, resized, etc.) before being vectorized because many VLMs need images to have specific dimensions (e.g., 224×224 pixels) before they can be processed. Thus, in embodiments of the inventive subject matter, objects in a key frame are each cropped and vectorized separately so that information is not lost in resizing. In some instances, a full key frame without any resizing or cropping can be vectorized, which can facilitate searching or VLLM processing that captures more information about a scene (e.g., “find a scene showing a road crossing on a rainy day”).

By carrying out the vectorizing tasks described above, a VLM (e.g., OpenCLIP, CLIP, ALIGN, ViLT, or the like) can be used to relate natural language (e.g., user queries or VLLM queries) with key frames and objects in those key frames making it possible to conduct text searches for those objects. A VLM of the inventive subject matter can be configured to accommodate multiple real-time streams of key frames—where rate that key frames can be processed depends on, e.g., frame selection that occurs in the frame preprocessing module—simultaneously without sacrificing video processing capabilities. When Tier 2 is described in this application as handling or processing key frames (or similar language), it should be understood that Tier 2 is vectorizing objects, images, and, in some cases, entire key frames.

Tier 2's high throughput capabilities can be useful in, e.g., embodiments where multiple security cameras are fed into one or more frame preprocessing modules and resulting key frames are passed to a single scene understanding module (e.g., a scene understanding module running on restricted hardware environment like a personal computer). A VLM implemented in Tier 2 can be tuned using application and domain specific datasets (e.g., datasets that relate objects that appear in images to text that are sourced from, for example, surveillance footage). And VLMs of the inventive subject matter can feature at least two modules: an image encoder and a text encoder. VLMs can use those encoders to vectorize images and text to facilitate vectorized searching and VLLM processing.

A practical example of a VLM model is one developed by OpenAI, CLIP, which is trained on a variety of (image, text) pairs. OpenAI's model can predict the most relevant text snippet given an image, without directly optimizing for the task, similar to the zero-shot capabilities of GPT-2 and GPT-3. The VLM can be fine-tuned to custom datasets and is capable of performing tasks such as image classification and finding the similarity between an image and a set of text descriptions. Tier 2 thus uses output from Tier 1. Where Tier 1 detects objects, Tier 2 vectorizes those objects to facilitate text-based object searching. For example, a searchable interface could be provided that is overlaid over video content as it plays.

By vectorizing images containing objects that are present in key frames, Tier 2 makes it possible to use language to associate objects with other objects (e.g., objects or people). By linguistically associating objects with other objects that appear in a set of key frames, events that occur in the corresponding scene can be better described.

Because key frames (e.g., segmented objects within key frames, entire key frames, etc.) have been processed according to Tier 1 and then vectorized according to Tier 2, efficient text-based searches or text-based VLLM processing of scene content is made possible. Vectorized searching, also known as vector search, is a method in artificial intelligence and data retrieval that uses mathematical vectors to represent and efficiently search through complex, unstructured data. Unlike traditional keyword-based search methods, vector search represents data points as vectors in a highly-dimensional space, allowing for more sophisticated and accurate searches. This method is particularly useful for finding related data by comparing the similarity of query vectors to data vectors, often using algorithms like cosine similarity or Euclidean distance.

Thus, when objects are identified in key frames and then vectorized, natural language queries can be received, vectorized, and used to search through key frames to find images or objects in a scene. For example, users can conduct vector searches that can match queries to the most relevant vectorized object(s) in a scene. Vectorized searching can also be used to generate contextualized descriptions of how multiple objects in a scene interact with one another (e.g., “show a red car colliding with a blue car”).

As mentioned above, Tier 2 can vectorize object image crops and/or full key frames to facilitate text-image and image-image search. A text-image search is one where a text query is input and an image result is returned, and an image-image search is one in which a user uploads an image of an object and an image result is returned.

In addition to vectorized searching, Tier 2 facilitates processing by a VLLM in Tier 3. Tier 3 implements one or more VLLMs (Vision Large Language Models) to carry out additional scene processing to attain a contextualized understanding of a scene. A VLLM is a type of multimodal model that is capable of interpreting both visual and textual information. VLLMs can be commercially distributed (e.g., GPT) or open source (e.g., InternVL2, Qwen2-VL, etc.). Open source VLLMs can be useful for customization and fine-tuning purposes. Other suitable multimodal models capable of interpreting at least both visual and textual information can be used in some embodiments, and multimodal models capable of interpreting other information types in addition to visual and textual, including audio, can be implemented in some embodiments.

In general, the VLLM implemented in Tier 3 will be slower and less accurate for tasks that are undertaken by, e.g., Tier 1, which is why those tasks are taken out of the purview of Tier 3 in the first place. For example, object or text detection and segmentation can be handled by a VLLM, but because VLLMs require far more computing resources than the dedicated sub-modules that can exist in Tier 1, Tier 1 is responsible for those tasks. Moreover, outputs from Tier 1 can strengthen reasoning capabilities of VLLM models in Tier 3. For instance, a VLLM could miss a smaller object that appears in a video, but the specialized sub-modules in Tier 1 may not have issues detecting that same object, and when a small, miss-able object is detected in Tier 1, it ensures that object can be interpreted by a VLLM in Tier 3.

Tier 1 outputs (e.g., bounding box locations of an object, an augmented form with an object segmented out to have a specific highlight color, or each object annotated with a tracking ID, or the like) can thus provide extra information that helps a VLLM in Tier 3 to better understand a scene. For example, say there are five cars in a four-lane road. Tier 1 could detect all the cars, draw bounding boxes around them, and associate tracking IDs with each of the cars. This task ensures that the VLLM in Tier 3 considers all five of the cars when the VLLM on its own might not have detected all five.

In some situations, VLLMs are not good at detecting domain specific objects (i.e., objects that exist within a pre-defined set of objects such as medical images, vehicles, and so on). But Tier 1 can find domain specific objects more easily because Tier 1 is configured specifically for object detection, regardless of object domain.

VLLMs of the inventive subject matter can be configured to carry out open vocabulary object detection. Thus, in general, VLLMs can receive different types of input, including a query in the form of one or more of any of an image (or a set of images), and/or text, where the text could be a simple question or a complex instruction. For example, a VLLM can receive an object description as text and use that object description to output bounding boxes containing the described object. In this way, a VLLM can make user-specified object detection unnecessary. For example, a user might not know all objects that should be detected in a set of key frames. A VLLM, on the other hand, does not need a list of objects to detect and can instead detect objects in key frames as needed. VLLMs are comparatively slower than traditional detectors and classifiers, which is why Tiers 1 and 2 carry out tasks to minimize how much processing power will be required by a VLLM to carry out the tasks of Tier 3. VLLMs of the inventive subject matter are thus configured to receive an image or video along with text (or just text) as a query and to generate a text answer as an output. The output can be formatted as, e.g., JSON, plain text, and so on, and it can be included in a detailed frame document that scene understanding modules of the inventive subject matter are configured to generate.

Because VLLMs can simultaneously process both text and images to provide a textual output, scene understanding modules of the inventive subject matter are capable of using key frames to generate in-depth textual descriptions of a scene that are further enriched using information available via Tier 1 and Tier 2 processing. Tier 2 output can optionally be used in Tier 3, depending on Tier 3 model architecture as discussed below regarding image encoding. Although VLLMs can provide information regarding objects and their interactions, VLLMs are not deterministic, which can make them unreliable. To keep VLLMs grounded, so to speak, information from Tier 1 can be used to minimize instances of a VLLM deviating from reality by focusing it on objects that Tier 1 has identified.

A distinguishing feature of VLLMs is their ability to perform tasks requiring high-level reasoning across both text and visual modalities. For instance, they can generate detailed captions for images, provide in-depth explanations for visual content, or engage in multi-turn dialogues that incorporate visual context. The incorporation of LLMs like GPT within VLLMs allows for rich contextual interpretation, enabling tasks such as storytelling from images, answering detailed questions about visual scenes, and providing multimodal reasoning in fields like education, healthcare, and creative content generation. This synthesis of vision and language capabilities positions VLLMs as transformative tools for a wide range of applications.

Modern VLLMs tend to be slow, owing to trade-offs between size and performance. VLLMs are also generally capable of processing only a single real-time stream at a much lower frame rate. Because of these limitations, scene understanding modules of the inventive subject matter take the three-tiered approach described in this application. By running video content or scenes through Tiers 1 and 2 before applying a VLLM in Tier 3, the Tier 3 VLLM can run more efficiently because, in some embodiments, it would not need to carry out any of the tasks already performed by Tiers 1 and 2.

VLLMs use an image encoder to understand images. In some cases, a VLLM can use a VLM (e.g., OpenCLIP, CLIP, ALIGN, ViLT, or the like) as an image encoder. Because VLMs are bimodal and can handle both images and text, embodiments that use a VLM for image encoding give rise to two types of VLLM architectures: VLLMs that keep the image encoder frozen and only fine-tune the language model part, and VLLMs that fine-tune both the image encoder and the language model.

In embodiments where Tier 3 requires a VLM image encoder that has been frozen and not fine-tuned, then the VLM from Tier 2 can be used for image encoder (e.g., OpenCLIP, CLIP, ALIGN, ViLT, or the like). In other words, in some situations, the image encoder used in Tier 3 can be taken from Tier 2 in situations where the image encoder from the VLM in Tier 2 is also adequate for Tier 3.

Reusing the VLM from Tier 2 can reduce hardware resource consumption and improve efficiency. But where Tier 3 requires a VLM image encoder that is different from the VLM image encoder in Tier 2, then the VLM image encoder in Tier 2 is no longer considered to exist in the same space as the VLM text encoder and it instead enters the space of the VLLM. In such situations, the VLM encoder cannot be reused from Tier 2. In other words, if Tier 3 has image encoding requirements that cannot be satisfied by the VLM image encoder from Tier 2, then the Tier 2 VLM image encoder cannot be reused in Tier 3. A VLLM in Tier 3 can thus be configured to associate text queries with contextual information from key frames that are processed by Tier 1 to gather information about, e.g., weather, lighting, background, foreground, or other user defined parameters. Tier 3 text queries are set (e.g., pre-defined) before processing begins, and they can be applied to all key frames. Outputs from these queries can then be used in creating a frame document that the scene understanding module is configured to output.

An example query that can be applied in Tier 3 is: “describe the weather, lighting, background objects, foreground objects.” A scene understanding module of the inventive subject matter could incorporate a response to this query in a frame document. For example, when applying this query to key frame, the response to the query could be: “The weather is sunny, and the lighting is good. There is a billboard in the background. In the foreground are two persons.”

Thus, Tier 3 can use one or more VLLMs to generate general scene context and domain specific scene context. General scene context includes contextualized text descriptions of a scene (e.g., based on processing undertaken using key frames corresponding to the scene), foreground objects, background objects, weather, lighting, signs and posters, and so on. Domain specific scene context can include general scene descriptions.

Once all Tiers 1, 2, and 3 have been applied via the scene understanding module, the scene understanding module outputs a detailed frame document that features comprehensive scene understanding. Frame documents of the inventive subject matter can be formatted as, e.g., JSON, text, or the like. Frame documents can be formatted for human user consumption (e.g., arranged and formatted in a way that is easy for a user to interpret and understand), they can be formatted to contain information in one or more data structures that are conducive to information storage and later retrievable by a computer, or, in some embodiments, both. Outputs from scene understanding modules of the inventive subject matter can, for example, be used to create a user interface having a search feature that allows users to use plain language text searching to search through video content.

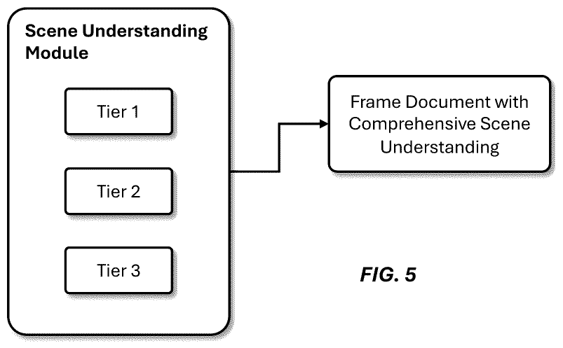

FIG. 4 is a flowchart demonstrating how a method based on the inventive subject matter described in this application can be organized. It should be understood that embodiments described in relation to FIGS. 4 and 5 can incorporate all subject matter described in this application as it relates to different method steps, whether explicitly restated in describing these method steps or disclosed above in the context of FIGS. 1-3.

In step 400, video is received by a frame preprocessing module from a video source. Possible video sources are described above in FIG. 1. The frame preprocessing module exists on, e.g., a computing device or set of computing devices, whether local, remote, cloud, etc. In step 402, the frame preprocessing module decodes the video and selects key frames from the decoded video. In some embodiments, the frame preprocessing module can perform further preprocessing by, e.g., resizing key frames, cropping key frames, and so on, as described above.

Once the frame preprocessing module has completed its tasks, key frames are ready for additional processing by Tiers 1, 2, and 3. Each key frame is thus subject to the object understanding framework of Tier 1, which includes several steps. Step 406 describes object detection, step 408 describes object segmentation, step 410 describes object classification, step 412 describes applying optical character recognition (OCR), step 414 describes applying a computer vision logic system, and step 416 describes applying other computer vision models (which can be done on an as-needed basis). Each of steps 406-416 are described in detail above and in relation to Tier 1's object understanding framework. In some embodiments, not every one of steps 406-416 must be carried out for Tier 1 to be considered complete.

Once Tier 1 processing is complete, and an object level understanding of each key frame has been developed. Tiers 2 and 3 can then use information from Tier 1 to conduct further processing. Although Tiers 1, 2, and 3 are not shown as operating in sequence (e.g., arrows from step 402 go to each of the Tiers individually), it should be understood from discussion of the Tiers presented in this application that, in some embodiments, processing that takes place within individual Tiers can be used in other Tiers in sequence.

Tier 2 uses a VLM to carry out its steps. In step 418, the VLM vectorizes (sometimes describes as “encoding”) images, and in step 420, the VLM vectorizes text. The images vectorized in step 418 can include key frames or portions of key frames. For example, if an object is segmented out in Tier 1, then the segmented image may be vectorized, while in other circumstances entire key frames are vectorized. Text that can be vectorized includes text content that appears in a key frame or segmented key frame. For example, if in step 412, text on a sign that appears in a key frame is subject to OCR, then that text can be vectorized in step 420.

Metadata text generated in Tier 1 can also be vectorized. For example, object classification carried out in step 410 can generate object classification metadata (e.g., a text-based object description), and that object classification metadata can then be vectorized in step 420. Text and image content that is vectorized in steps 418 and 420 can be used in Tier 3 as well as in a frame document that the scene understanding module generates, as described in FIG. 5.

Tier 3 features step 422, which involves using a VLLM to generate a contextualized scene understanding. As discussed above, the VLLM in Tier 3 runs pre-defined queries that generate contextual information about content in key frames (e.g., weather, lighting, and so on as described above). Carrying out Tiers 1 and 2 before moving to Tier 3 can improve the performance of step 422 in Tier 3 for the reasons discussed above in more detail.

Once Tiers 1-3 (and steps 406-422) have been applied to key frames, the scene understanding module (which comprises Tiers 1-3) can generate a frame document having comprehensive scene understanding. Thus, for example, the frame document can include object understandings and metadata generated in Tier 1, it can include vectorized images and text generated in Tier 2, and it can include contextualized scene information generated in Tier 3. In some embodiments, the contextualized scene information can incorporate information form Tiers 1 and 2.

Thus, specific systems and methods directed to the use of artificial intelligence to interpret video content in real time have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A multi-tiered video content understanding system comprising:
a frame preprocessing module configured to receive encoded video;
the frame preprocessing module being further configured to decode the video to create a decoded video and to select key frames from the decoded video, where the key frames correspond to a scene;
a scene understanding module comprising a first tier, a second tier, and a third tier;
wherein the scene understanding module is configured to receive the key frames from the frame preprocessing module;
the first tier being configured to isolate an object in the scene by detecting the object in at least one key frame, segmenting the object in the at least one key frame into a segmented object image, and applying a computer vision logic system to the at least one key frame to identify object information;
the second tier comprising a VLM that is configured to vectorize at least a portion of the at least one key frame that contains the object to create a vectorized object image;
the third tier comprising a VLLM that is configured to generate a contextual description of the scene based on the at least one key frame using the vectorized object image and/or the object information; and
wherein the scene understanding module outputs a detailed frame document comprising the contextual description of the scene and the vectorized object image.

2. The system of claim 1, wherein the first tier is further configured to generate information about the object, the information about the object comprising at least one of a tracking ID, a location of the object, a duration that the object appears in the scene, an indicator as to whether the object is moving or stationary, a direction of movement, and whether the object is in a region of interest.

3. The system of claim 2, wherein the contextual description of the scene further comprises the object information.

4. The system of claim 1, wherein the VLM comprises a Contrastive Language-Image Pre-training model (CLIP) model.

5. The system of claim 1, wherein the VLM comprises an image encoder configured to vectorize images.

6. The system of claim 1, wherein the key frames are a subset of total frames that make up the scene from the decoded video.

7. The system of claim 1, wherein the third tier comprising is configured to generate the contextual description of the scene by running a pre-defined query.

8. A multi-tiered video content understanding system comprising:
a frame preprocessing module configured to receive a video and to identify key frames in the video that correspond to a scene;
a scene understanding module comprising a first tier, a second tier, and a third tier;
the first tier being configured to identify an object in a key frame and to generate object information about the object;
the second tier comprising a VLM that is configured to create a vectorized image containing the object; and
the third tier comprising a VLLM that is configured to apply a predefined query to generate a contextual description of the key frame.

9. The system of claim 8, wherein the frame preprocessing module receives an encoded video and the frame preprocessing module decodes the encoded video to create the video.

10. The system of claim 8, wherein the object information comprises at least one of a tracking ID, a location of the object, a duration that the object appears in the scene, an indicator as to whether the object is moving or stationary, a direction of movement, and whether the object is in a region of interest.

11. The system of claim 10, wherein the contextual description of the object in the scene further comprises the information about the object.

12. The system of claim 8, wherein the first tier is further configured to apply a computer vision logic system to the segmented object image.

13. The system of claim 8, wherein the VLM comprises image encoder configured to vectorize images.

14. The system of claim 8, wherein the key frames are a subset of total frames that make up the scene from the video.

15. The system of claim 8, wherein the VLM comprises a Contrastive Language-Image Pre-training model (CLIP) model.

16. The system of claim 8, wherein the first tier further comprises an OCR sub-module.

17. The system of claim 8, wherein the third tier uses the object information and the vectorized image to generate the contextual description of the key frame.
